(19) United States
(12) Patent Application Publication
(10) Pub. No.: US 2022/0126675 A1
(43) Pub. Date: Apr. 28, 2022

(54) Hybrid Transmission for Motor Vehicle, and Motor Vehicle Powertrain

(71) Applicant: ZF Friedrichshafen AG, Friedrichshafen (DE)

(72) Inventors: Stefan Beck, Eriskirch (DE); Fabian Kutter, Kressbronn (DE); Martin Brehmer, Tettnang (DE); Matthias Horn, Tettnang (DE); Thomas Martin, Weissensberg (DE); Michael Wechs, Weißensberg (DE); Thomas Kroh, Lindau (DE); Oliver Bayer, Hörbranz (AT); Peter Ziemer, Tettnang (DE); Johannes Kaltenbach, Friedrichshafen (DE); Max Bachmann, Friedrichshafen (DE)

(21) Appl. No.: 17/436,185

(22) PCT Filed: Oct. 15, 2019
(86) PCT No.: PCT/EP2019/077892

§ 371 Date: Sep. 3, 2021

(30) Foreign Application Priority Data
Mar. 5, 2019 (DE) 10 2019 202 973.6

(51) Int. Cl. B60K 6/547; B60K 6/36; F16H 3/091; B60K 6/48

(52) U.S. Cl. CPC B60K 6/547; B60K 6/36; F16H 3/091; B60K 2006/4825; B60Y 2200/92; F16H 2200/0069; B60K 6/48

(57) ABSTRACT

A hybrid transmission (10) for a motor vehicle drive train with an internal combustion engine (55) and an electric prime mover (18) is provided. The hybrid transmission (10) includes a first sub-transmission (10a) with multiple gear steps and a first transmission input shaft (12), a second sub-transmission (10b) with multiple gear steps and a second transmission input shaft (14), a countershaft (16), multiple shift elements (A, B, C, D, E) for engaging the gear steps (1, 2, 3, 4, 5), and gearwheel pairs of idler gears (28, 32, 36, 40, 44) and fixed gears (26, 30, 34, 38, 42) for forming the gear steps, arranged in multiple gear set planes. A portion of the gear steps is engageable for the internal combustion engine, and a portion of the gear steps is engageable for the electric prime mover. The gearwheel pairs for forming the gear steps having the lowest and the second-lowest ratios are fixedly associated with the first sub-transmission.

### CROSS-REFERENCE TO RELATED APPLICATIONS

The present application is related and has right of priority to German Patent Application No. 102019202973.6 filed in the German Patent Office on Mar. 5, 2019 and is a nationalization of PCT/EP2019/077892 filed in the European Patent Office on Oct. 15, 2019, both of which are incorporated by reference in their entirety for all purposes.

### FIELD OF THE INVENTION

The present invention relates generally to a hybrid transmission for a motor vehicle drive train and to a motor vehicle drive train with a hybrid transmission of this type.

### BACKGROUND

Vehicles are increasingly equipped with hybrid drives, i.e., with at least two different drive sources. Hybrid drives can contribute to the reduction of fuel consumption and pollutant emissions. Drive trains having an internal combustion engine and one or multiple electric motors have largely prevailed as a parallel hybrid or as a mixed hybrid. These types of hybrid drives have an essentially parallel arrangement of the internal combustion engine and of the electric drive in the power flow. Here, a superposition of the drive torques as well as a control with a purely internal combustion engine-generated drive or a purely electric motor-generated drive is made possible. Since the drive torques of the electric drive and of the internal combustion engine can add up, depending on the control, a comparatively smaller configuration of the internal combustion engine and/or intermittent shut-down of the internal combustion engine are/is possible, as the result of which a significant reduction of the carbon dioxide (CO₂) emissions can be achieved without significant losses of power and/or comfort. The possibilities and advantages of an electric drive can thereby be combined with the range, power, and cost advantages of internal combustion engines.

One disadvantage of the aforementioned hybrid drives consists of a generally more complex configuration, since both drive sources preferably transmit input power to an input shaft with only one transmission. Moreover, individual gear steps can be utilized at times by only one drive source. A reduction of the complexity of the configuration of a hybrid transmission is usually associated with a loss of variability.

Publication DE 10 2010 030 573 A1 describes a hybrid drive with an automated transmission, for example, for a motor vehicle, with an internal combustion engine, which is drivingly connected to at least one first transmission input shaft, and with an electric drive, which includes at least one electric machine, which is drivingly connected to a second transmission input shaft. The two transmission input shafts are arranged coaxially to each other, wherein a gear change device, in one of shift positions of the gear change device, drivingly connects the two transmission input shafts to each other and, in another shift position, shifts a gear.

The disadvantage of previous approaches is that only a portion of the gear steps can be associated with the electric prime mover. The low gear steps for the electric prime mover are often advantageous, since electric machines can be operated at high rotational speeds. The potential of the electric prime mover can be optimally exploited in the low gear steps. A portion of the low gear steps of the electric prime mover is unavailable, however.

### SUMMARY OF THE INVENTION

Example aspects of the present invention provide a hybrid transmission and a drive train having a better combinability of the internal-combustion-engine and electric-motor gear steps. In particular, a hybrid transmission and a drive train are to be created, which, due to properties with regard to small installation space, high variability, and efficient manufacturability, are suitable for a serial production in the automotive industry. Preferably, the low gear steps, which can be associated with the electric prime mover, are to have a small ratio step.

Example aspects of the invention relate to a hybrid transmission for a motor vehicle drive train having an internal combustion engine and an electric prime mover, with: a first sub-transmission having multiple gear steps and a first transmission input shaft; a second sub-transmission having multiple gear steps and a second transmission input shaft; a countershaft; multiple shift elements for engaging the gear steps; and gearwheel pairs of idler gears and fixed gears arranged in multiple gear set planes for forming the gear steps. A portion of the gear steps is engageable for the internal combustion engine and a portion of the gear steps is engageable for the electric prime mover. The gearwheel pairs for forming the gear steps having the lowest and the second-lowest ratios are fixedly associated with the first sub-transmission.

Example aspects of the present invention, furthermore, provide a motor vehicle drive train having: an internal combustion engine for providing input power; an electric prime mover for providing input power; and a hybrid transmission as described above.

It is understood that the features, which are mentioned above and which will be described in greater detail in the following, are usable not only in the particular combination indicated, but also in other combinations or alone, without departing from the scope of the present invention.

The electric prime mover preferably utilized as a main propulsive machine can utilize the gear steps having the lowest and the second-lowest ratios. This is advantageous, in particular, in special cases such as, for example, in the presence of high driving resistance. Here, the electric prime mover can utilize the first gear, i.e., the lowest gear stage, in the first sub-transmission. In a purely electric operation, the electric prime mover can utilize the two lowest gear steps and be operated with high efficiency. The preferred example design is an arrangement in the front-mounted transverse design or the rear-mounted transverse design, i.e., having a lateral drive output.

In one preferred example embodiment, the hybrid transmission has five gear steps, wherein all gear steps are engageable for the internal combustion engine and the electric prime mover. Due to the provision of five gear steps, the hybrid transmission can be designed to be weight- and cost-efficient. The hybrid transmission has a low installation space requirement, and so an application for small vehicles is also possible. Due to the combinability of the gear steps, a high variability and efficiency of the hybrid transmission can be achieved. In particular, at least three gear steps of the first electric prime mover can be made available. Preferably, no winding-path gear steps are provided. The loading of the components is minimized.

In one preferred example embodiment, one gearwheel pair of the gear steps larger than the second gear step is arranged at another sub-transmission than the gearwheel pairs of adjacent gear steps. As a result, a tractive force loss-free shift into the higher gear steps can be achieved. A gear change is comfortably carried out. The motor vehicle accelerates faster and the hybrid transmission shifts more efficiently.

In one further preferred example embodiment, the first sub-transmission and/or the second sub-transmission are/is designed for establishing a power transmission path with the electric prime mover and/or a further electric prime mover. A technically simple connection of the electric prime mover to the hybrid transmission is achieved. The component requirements for the hybrid transmission can remain low. Moreover, the further electric prime mover can be utilized for entraining the internal combustion engine into motion, and so, if necessary, a starter motor for the internal combustion engine can be dispensed with. A serial operation can be established, in which the internal combustion engine drives the further electric prime mover, in order to supply the electric prime mover with energy. Moreover, the further electric prime mover can assist the internal combustion engine during a synchronization for gear changes in a hybrid operation.

In one further preferred example embodiment of the above-described hybrid transmission, the first sub-transmission and/or the second sub-transmission are/is designed for establishing the power transmission path at the fixed gear of the gear pair that forms the highest gear step on the first sub-transmission and/or the second sub-transmission. In this way, a high reduction ratio for the electric prime mover can preferably be achieved without further gear stages. The transmission is lightweight and relatively uncomplicated, since fewer components must be utilized.

In one further preferred example embodiment of the above-described hybrid transmission, a fixed gear arranged at one axial end of the hybrid transmission is designed for establishing a power transmission path with the electric prime mover and/or the further electric prime mover. In this way, an axially long electric prime mover having high power can be installed. The hybrid transmission remains compact and a drive train with a hybrid transmission of this type can be powerful and efficient.

In one further preferred example embodiment, the idler gear of the first gear step and/or of the second gear step includes, together with a further gear-forming gearwheel pair, a shared shift element. Alternatively or additionally, the shift elements are designed as form-locking shift elements. Additionally or alternatively, furthermore, at least two shift elements are designed as double shift elements, which are actuatable by a double-acting actuator. Due to the provision of double shift elements, the control during gear changes can be simplified. In addition, the number of actuators needed for the open-loop control of the hybrid transmission can be kept low. The hybrid transmission has a low design complexity. Due to the provision of form-locking shift elements, the hybrid transmission can be designed to be cost-efficient and less susceptible to error.

In one preferred example embodiment, the hybrid transmission includes a first coupling element and a second coupling element for operatively connecting shafts in the hybrid transmission. The first transmission input shaft is operatively connectable to the internal combustion engine by the first coupling element and the second transmission input shaft is operatively connectable to the internal combustion engine by the second coupling element. The first coupling element and the second coupling element are designed as form-locking coupling elements. Due to the operative connection of the first transmission input shaft and/or the second transmission input shaft to the internal combustion engine, all gear steps for the internal combustion engine are usable. The internal combustion engine can be efficiently operated.

In one particularly preferred example embodiment, the first coupling element and the second coupling element are actuatable by a double-acting actuator. Due to the fact that the coupling elements are actuatable by a double-acting actuator, the number of actuators needed for the open-loop control of the hybrid transmission can be kept low. The hybrid transmission can be designed to be cost-efficient and less susceptible to error.

In one preferred example embodiment, the hybrid transmission includes a connecting element for the driving connection of the first transmission input shaft and the second transmission input shaft. In this way, all gear steps for the electric prime mover are usable. The hybrid transmission is variably usable.

In one preferred example embodiment, the first transmission input shaft and the second transmission input shaft are arranged coaxially to each other. One of the transmission input shafts is designed as a hollow shaft and encompasses the other transmission input shaft, at least partially or in sections. As a result, the transmission can be designed to be compact. Moreover, due to the advantageous example arrangement of the transmission input shafts, a shared countershaft can be utilized, which simplifies the assembly of the hybrid transmission.

In one preferred example embodiment, the motor vehicle drive train includes a further electric prime mover for providing input power. As a result, the internal combustion engine can be designed having smaller dimensions, since assistance can take place by the further electric prime mover. A consumption of fossil fuels can be reduced.

In one preferred example embodiment, the electric prime mover and/or the further electric prime mover are/is arranged axially parallel to the first transmission input shaft and/or the second transmission input shaft. As a result, the connection to the motor vehicle drive train can be simplified. In addition, the drive train can be compact.

A gear step changeover takes place by disengaging one shift element and simultaneously engaging the shift element for the next-higher or next-lower gear step. The second shift element therefore gradually takes on the torque from the first shift element until, by the end of the gear step changeover, the entire torque has been taken on by the second shift element. If synchronization is carried out in advance, a gear change can take place faster.

A coupling element is understood, in the present case, to be a component that can detachably operatively connect a prime mover, such as an internal combustion engine or an electric prime mover, to a shaft, preferably a transmission input shaft.

A connecting element, in the present case, is a component that can detachably operatively connect two shafts.

Entraining the internal combustion engine into motion is understood to mean starting the internal combustion engine or setting the internal combustion engine into rotation. The entrainment into motion takes place by at least partially engaging a friction clutch with a gear step engaged and the ignition switched on, wherein the ‘momentum’ of a vehicle in motion, i.e., the kinetic energy, is transmitted by the power train to the internal combustion engine.

In the present case, an internal combustion engine can be any machine that can generate a turning motion by burning a fuel, such as gasoline fuel, diesel fuel, kerosene, ethanol, liquefied gas, liquefied petroleum gas, etc. An internal combustion engine can be, for example, a spark-ignition engine, a diesel engine, a Wankel rotary piston Engine®, or a two-stroke engine.

An actuator in the present case is a component that converts an electrical signal into a mechanical motion. Preferably, actuators that are utilized with double shift elements carry out movements in two opposite directions, in order to engage one shift element of the double shift element in the first direction and to engage the other shift element in the second direction.

A ratio step is understood to be the difference in the ratio of two, preferably adjacent, gear steps. A low ratio step means that the ratio of the gear steps differs only a little. Ratio steps between adjacent gear steps are therefore smaller than ratio steps, in which one gear step is left out.

A serial driving operation is understood to be an operating mode, in which the internal combustion engine acts as a drive for an electric prime mover operated as a generator, which supplies a further electric prime mover, and so the internal combustion engine is decoupled from the driving wheels and, preferably, can be operated continuously at a single, low-emission operating point.

A fixed assignment of gearwheel pairs for forming a gear step to a sub-transmission is to be understood to mean that the formed gear step can be utilized only for transmitting input power when the input power is introduced into the transmission via the appropriate transmission input shaft of the sub-transmission.

### BRIEF DESCRIPTION OF THE DRAWINGS

The invention is described and explained in greater detail in the following with reference to a few selected exemplary embodiments in conjunction with the attached drawings, in which:

FIG. 1 shows a schematic of an example embodiment of a hybrid transmission according to the invention in a first variant;

FIG. 2 shows a schematic of a gear shift matrix of the hybrid transmission according to example aspects of the invention from FIG. 1;

FIG. 3 shows a schematic of an example embodiment of a hybrid transmission according to example aspects of the invention;

FIG. 4 shows a schematic of a gear shift matrix of the hybrid transmission according to example aspects of the invention from FIG. 3;

FIG. 5 shows a schematic of an example embodiment of a hybrid transmission according to example aspects of the invention in a second variant;

FIG. 6 shows a schematic of an example embodiment of a hybrid transmission according to example aspects of the invention in a third variant;

FIG. 7 shows a schematic of a gear shift matrix of the hybrid transmission according to example aspects of the invention from FIG. 6; and

FIG. 8 shows a schematic of an embodiment of a hybrid transmission according to example aspects of the invention in a fourth variant.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

FIG. 1 diagrammatically shows an example embodiment of a hybrid transmission 10 in a drive train 11 with a first transmission input shaft 12, a second transmission input shaft 14, and a countershaft 16. The first transmission input shaft 12 is designed as a solid shaft. The second transmission input shaft 14 is designed as a hollow shaft and encompasses the first transmission input shaft 12, at least partially or in sections.

The drive train 11, furthermore, includes a first electric machine 18. A fixed gear 20 is arranged at an output shaft of the electric prime mover 18, in order to drivingly connect the electric prime mover 18 to the hybrid transmission 10. The drive train 11, furthermore, includes a further electric prime mover 22, at the output shaft of which a fixed gear 24 is arranged, in order to drivingly connect the further electric prime mover 22 to the hybrid transmission 10.

The hybrid transmission 10 includes a first sub-transmission 10a and a second sub-transmission 10b, which are represented by dashed boxes. The hybrid transmission 10 includes a total of five gear steps, each of which is formed by one gearwheel pair made up of an idler gear and a fixed gear. A fixed gear 26 of the first gear step is arranged on the first transmission input shaft 12 and is in engagement with an idler gear 28. The idler gear 28 is arranged on the countershaft 16 and can be drivingly connected to the countershaft 16 by the shift element A. The fixed gear 30 of the second gear step is arranged on the countershaft 16 and is in engagement with an idler gear 32, which is arranged on the first transmission input shaft. The idler gear 32 can be connected to the first transmission input shaft 12 by the shift element B. A fixed gear 34 of the third gear step is arranged on the second transmission input shaft 14 and is in engagement with an idler gear 36, which is arranged on the countershaft 16. The idler gear 36 can be connected to the countershaft 16 by the shift element C. The fixed gear 38 of the fourth gear step is arranged at the first transmission input shaft 12 and is in engagement with an idler gear 40. The idler gear 40 is arranged at the countershaft 16 and can be drivingly connected to the countershaft 16 by the shift element D. In addition, the fixed gear 38 is designed for establishing a power transmission path with the electric prime mover 18, preferably by an engagement with the fixed gear 20. A fixed gear 42 of the fifth gear step is arranged at the second transmission input shaft 14 and in engagement with an idler gear 44, which is arranged at the countershaft 16. The idler gear 44 can be drivingly connected to the countershaft 16 by the shift element E. The fixed gear 42 is also designed for establishing a power transmission path with the further electric prime mover 22, preferably by an engagement with the fixed gear 24, as indicated by the dashed line.

In addition, a first output gearwheel 46 in the form of a fixed gear is arranged at the countershaft 16 and is in engagement with a second output gearwheel 48 and forms the drive output. The second output gearwheel 48 is drivingly connected to a differential 50, in order to transmit input power from a transmission input 52, the electric prime mover 18, and/or the further electric prime mover 22 to the driving wheels of a motor vehicle.

The shift elements E, C are combined to form a double shift element EC. The shift elements A, D are combined to form a double shift element AD. The gearwheels and shift elements of the gear steps 1, 2, and 4 are arranged in a first sub-transmission 10a. The gearwheels and shift elements of the gear steps 3 and 5 are arranged in a second sub-transmission 10b. The gearwheels are preferably designed as spur gears.

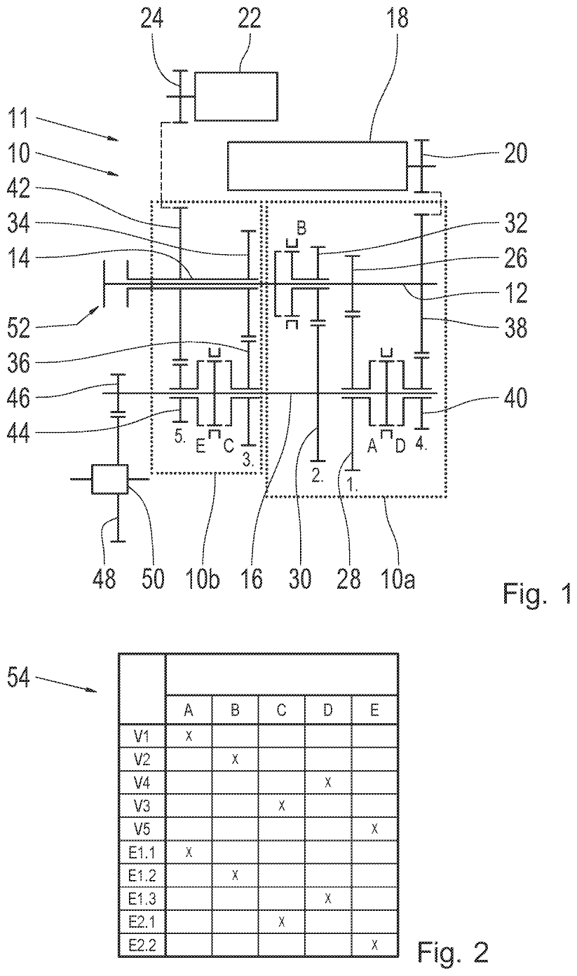

FIG. 2 shows a gear shift matrix 54 of the hybrid transmission from FIG. 1. In the first column, the internal-combustion-engine gear steps V1 through V5 of the internal combustion engine 55 and the electric-machine gear steps E1.1 through E1.3 of the electric prime mover 18 and the electric-machine gear steps E2.1 through E2.2 of the further prime mover 22 are listed. Consequently, which of the gear stages 1 through 5 of the hybrid transmission 10 corresponds to which of the internal-combustion-engine gear steps V1 through V5, and which of the electric-machine gear steps E1.1 through E1.3 and E2.1 through E2.2 is apparent from the gear shift matrix 54. In the second to sixth columns, the shift conditions of the individual shift elements A through E are shown, wherein an “X” means that the shift element is engaged, i.e., drivingly connects the idler gear associated therewith to the shaft associated therewith. For the internal-combustion-engine gear step V1, the shift element A is engaged. For the internal-combustion-engine gear step V2, the shift element B is engaged. For the internal-combustion-engine gear step V3, the shift element C is engaged. For the internal-combustion-engine gear step V4, the shift element D is engaged. For the internal-combustion-engine gear step V5, the shift element E is engaged.

For the electric-machine gear step E1.1 of the electric prime mover 18, the shift element A is engaged. For the second electric-machine gear step E1.2 of the electric prime mover 18, the shift element B is engaged. For the third electric-machine gear step E1.3 of the electric prime mover 18, the shift element D is engaged. For the first electric-machine gear step E2.1 of the further electric prime mover 22, the shift element C is engaged. For the second electric-machine gear step E2.2 of the further electric prime mover 22, the shift element E is engaged.

It is understood that the other shift elements, which were not explicitly designated as engaged, are to be considered to be disengaged in the corresponding configuration. These other shift elements, therefore, do not connect the idler gear associated with the shift element to the shaft associated with the shift element. It is understood, furthermore, that the electric-machine gear steps and the internal-combustion-engine gear steps can be combined with one another in a hybrid operation, i.e., for example, travel can take place in the internal-combustion-engine gear step V2 and, additionally, also in the second electric-machine gear step E1.2 of the electric prime mover 18. For this purpose, the shift element B would simply need to be engaged.

In a purely electric operation, the electric prime mover 18 can transmit input power by the electric-machine gear steps E1.1 through E1.3, i.e., utilize the gear steps of the first, second, and fourth gears for power transmission. Additionally or alternatively, the further electric prime mover 22 can transmit input power by the electric-machine gear steps E2.1 and E2.2, i.e., utilize the third and fifth gear steps for power transmission.

In a hybrid operation, the electric prime mover 18 transmits input power by the electric-machine gear steps E1.1 through E1.3. Additionally or alternatively, the further electric prime mover 22 transmits input power by the electric-machine gear steps E2.1 or E2.2. Additionally, an internal combustion engine 55 connectable at the transmission input to the first transmission input shaft 12 or the second transmission input shaft 14 transmits input power by the internal-combustion-engine gear steps V1 through V5. During the transmission of input power of the internal combustion engine by the internal-combustion-engine gear steps V1, V2, and V4, the internal combustion engine is drivingly connected to the first transmission input shaft 12. During the transmission by the internal-combustion-engine gear steps V3 or V5, the internal combustion engine is connected to the second transmission input shaft 14.

In a purely internal combustion engine-driven operation, the internal combustion engine can transmit input power by the internal-combustion-engine gear steps V1 through V5. The electric prime movers 18, 22 are preferably not operated in this case.

It is also conceivable to establish a serial operation, in which the internal combustion engine drives the further electric prime mover 22. In the process, the internal combustion engine 55 is connected to the second transmission input shaft 14 and entrains the further electric prime mover 22, which is operated as a generator. The energy generated in this way can then be supplied to the electric prime mover 18, wherein the electric prime mover 18 provides input power by the electric-machine gear steps E1.1 through E1.3.

Identical reference characters refer to identical features and are not explained in greater detail in the following. The differences in the example embodiments are explained in greater detail.

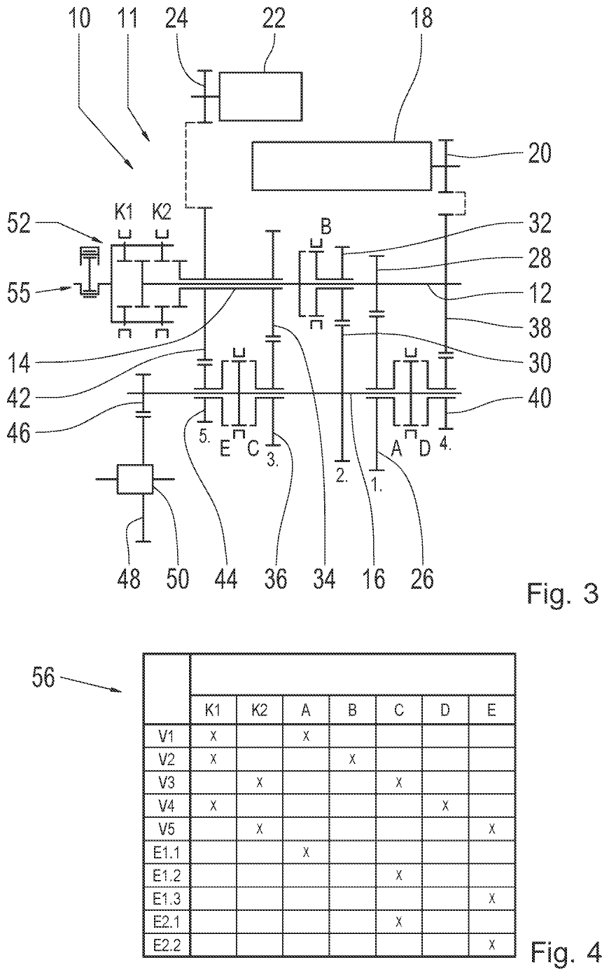

In FIG. 3, a variant of a hybrid transmission 10 according to example aspects of the invention is shown in a drive train 11. As an addition to the hybrid transmission 10 shown in FIG. 1, a first coupling element K1 and a second coupling element K2 are shown at the transmission input 52. Moreover, the internal combustion engine 55 is shown at the transmission input. By the coupling element K1, the internal combustion engine 55 can be drivingly connected to the first transmission input shaft 12. By the second coupling element K2, the internal combustion engine 55 can be drivingly connected to the second transmission input shaft 14.

In FIG. 4, a gear shift matrix 56 of the example embodiment of the hybrid transmission 10 in the drive train 11 shown in FIG. 3 is diagrammatically shown. The shift conditions of the coupling elements K1 and K2 are shown in the first two columns of the gear shift matrix 56. The shift conditions of the shift elements A through E are shown in the columns 3 through 7.

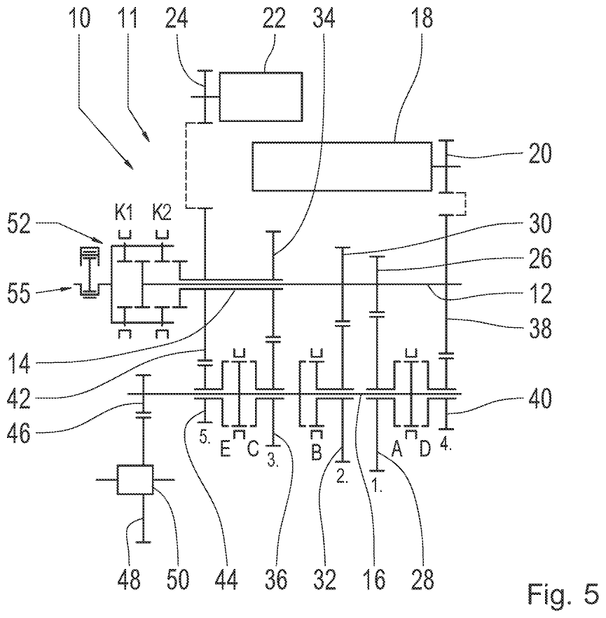

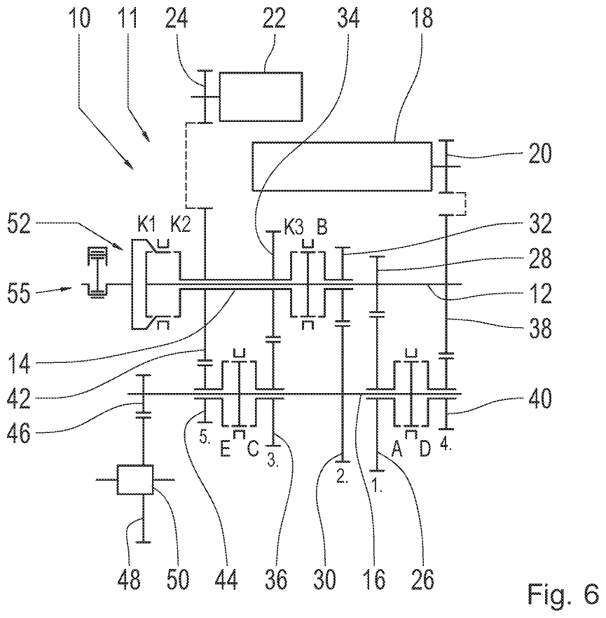

In FIG. 5, a second variant of a hybrid transmission 10 according to example aspects of the invention in a drive train 11 is diagrammatically shown. In contrast to the example embodiments shown in FIGS. 1 and 3, the shift element B is arranged on the countershaft 16. In addition, the idler gear 32 of the second gear step is arranged on the countershaft 16, wherein the fixed gear 30 of the second gear step is arranged on the first transmission input shaft 12. The gear shift matrix 56 shown in FIG. 4 can therefore describe the shift conditions of the example embodiment shown in FIG. 5. It is understood that other shift elements as well as the associated idler gears and fixed gears can also be appropriately interchanged, i.e., for example, from the countershaft 16 onto the first transmission input shaft 12 or the second transmission input shaft 14.

In FIG. 6, a third variant of a hybrid transmission 10 according to example aspects of the invention in a drive train 11 is diagrammatically shown. In contrast to the example embodiment shown in FIG. 5, a connecting element K3 is provided, in order to drivingly connect the first transmission input shaft 12 and the second transmission input shaft 14 to each other. Moreover, the first coupling element K1 is designed as a friction clutch. Due to the connecting element K3, the internal combustion engine 55 can always supply input power to the hybrid transmission 10 in a friction-locking manner, i.e., via the first coupling element K1. Consequently, only one friction clutch K1 is necessary, in order to utilize or engage, in a friction-locking manner, all gear steps present in the hybrid transmission 10 by the internal combustion engine 55. In this exemplary example embodiment, the second coupling element K2 is preferably utilized for connecting the internal combustion engine 55 to the further electric prime mover 22 during a serial operation. With a friction-locking coupling element K1, the following functions are possible: disengaging the coupling element K1 under load, such as, for example, during an emergency brake application; a purely internal combustion engine-driven starting operation; entraining the internal combustion engine 55 into motion during the travel, in order to start the internal combustion engine 55; and flywheel start of the internal combustion engine 55 by the further electric prime mover 22. Moreover, an engagement of the coupling element K1 is simplified, since a synchronization can be dispensed with or, preferably, only a slight synchronization is necessary.

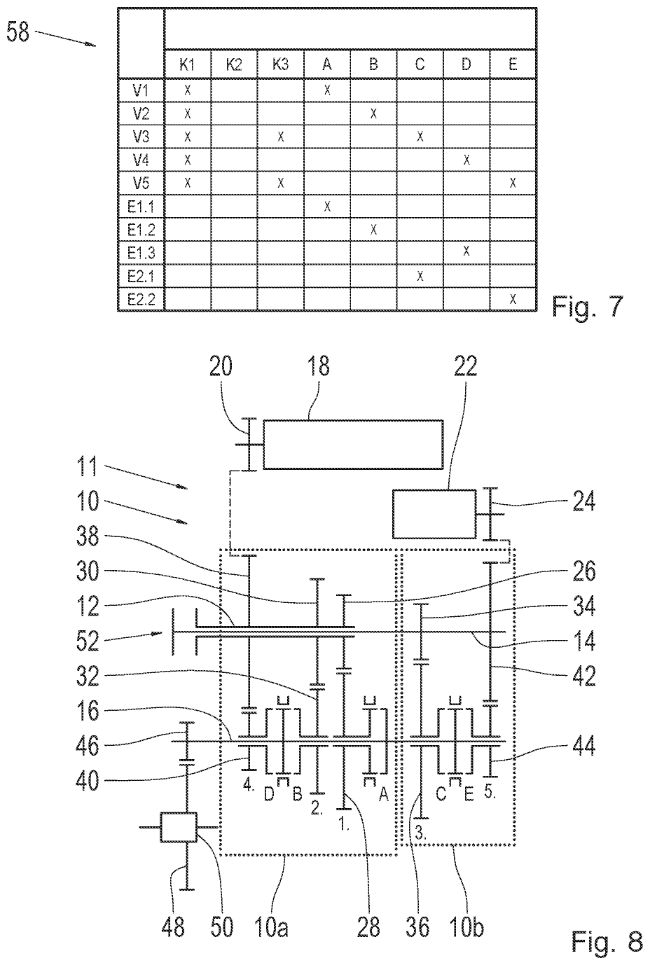

FIG. 7 shows a gear shift matrix 58 of the example embodiment shown in FIG. 6. In the first column, the shift condition of the first coupling element K1 is shown. In the second column, the shift condition of the second coupling element K2 is shown. In the third column, the shift condition of the connecting element K3 is shown. The shift conditions of the shift elements A through E are shown in the fourth through eighth columns.

In FIG. 8, a fourth variant of a hybrid transmission 10 according to example aspects of the invention in a drive train 11 is diagrammatically shown. For the sake of clarity, the internal combustion engine located at the transmission input 52 is not represented. In the example embodiment shown, the first transmission input shaft 12 is designed as a hollow shaft and the second transmission input shaft 14 is designed as a solid shaft, wherein the first transmission input shaft 12 at least partially encloses the second transmission input shaft 14. The gear steps of the first sub-transmission 10a are associated with the first transmission input shaft 12, i.e., represented by the first transmission input shaft 12 designed as a hollow shaft. The gear steps of the second sub-transmission 10b are represented by the second transmission input shaft 14 designed as a solid shaft. The gear order as viewed from the transmission input 52 is 4, 2, 1, 3, 5, whereas, in the example embodiments shown above, the gear order as viewed from the transmission input 52 is 5, 3, 2, 1, 4.

The electric prime mover 18 is drivingly connected to the first sub-transmission 10a via the fixed gear 38 and the fixed gear 20. The further electric prime mover 22 is drivingly connected to the second sub-transmission 10b by the fixed gear 42 and the fixed gear 24. The shift conditions of the example embodiment shown in FIG. 8 can be described by the gear shift matrix 54, which is shown in FIG. 2.

It is understood that, in all example embodiments shown, the shift elements of a gearwheel pair can also be arranged on a shaft other than the shaft that is shown. It is understood, furthermore, that the connection of the electric prime mover 18 or the further electric prime mover 22 can take place directly or via a pre-ratio. Moreover, it is also conceivable to connect the electric prime movers by a flexible traction drive mechanism. It is also conceivable to design one or both electric prime mover(s) as coaxial machines, in which a transmission input shaft forms the rotor, wherein the stator of the electric machine is arranged at a housing in a rotationally fixed manner.

In particular, the following example embodiment variants are conceivable:

an electric prime mover is connected at least one sub-transmission

an electric prime mover is connected at the first sub-transmission;

an electric prime mover is connected at both sub-transmissions;

the electric prime mover is connected at the fixed gear of the highest gear-forming gear pair;

the electric prime movers are each connected at the outermost fixed gear of a transmission main axis, in order to implement longer axially parallel electric prime movers;

the gear set includes at least five (5) gear-forming gear set pairs;

the sub-transmission having the first gear and the second gear includes at least one further gear-forming gear pair;

the first sub-transmission has the first, second, and fourth gears 1, 2, and 4;

the second sub-transmission has the gears third and fifth 3 and 5;

the idler gear of the first gear or the second gear includes, together with a further gear-forming gear pair, a shared shift element;

the shift elements A, B, C, D, E are designed as form-locking shift elements;

the electric prime movers are arranged axially parallel to the power train;

the shift elements E and C are designed as a double shift element;

the shift elements A and D are designed as a double shift element;

the input shafts are connectable to the internal combustion engine via the coupling elements K1 and K2;

the coupling elements K1 and K2 are designed as form-locking coupling elements;

the coupling elements K1 and K2 are designed as a double element;

a connecting element K3 is provided, which connects the two sub-transmissions to each other;

the connecting element K3 forms a double element with a gear-forming gear pair of the first sub-transmission;

the gears are arranged, starting from the input, in the order fifth, third, second, first, fourth 5, 3, 2, 1, 4 or fifth, third, first, second fourth 5, 3, 1, 2, 4; and

a parking lock is arranged on a pinion shaft for the differential.

The invention was comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. The mere mention of a few measures in multiple various dependent claims is not to be understood to mean that a combination of these measures cannot also be advantageously utilized.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid transmission
10a first sub-transmission
10b second sub-transmission
11 drive train
12 first transmission input shaft
14 second transmission input shaft
16 countershaft
18 electric prime mover
20 fixed gear of the electric prime mover
22 further electric prime mover
24 fixed gear of the further electric prime mover
26 fixed gear of the first gear step
28 idler gear of the first gear step
30 fixed gear of the second gear step
32 idler gear of the second gear step
34 fixed gear of the third gear step
36 idler gear of the third gear step
38 fixed gear of the fourth gear step
40 idler gear of the fourth gear step
42 fixed gear of the fifth gear step
44 idler gear of the fifth gear step
46 first output gearwheel
48 second output gearwheel
50 differential
52 transmission input
54 gear shift matrix
55 internal combustion engine
56 gear shift matrix
58 gear shift matrix
A shift element
B shift element
C shift element
D shift element
E shift element
K1 first coupling element
K2 second coupling element
K3 connecting element

1-14. (canceled)

15. A hybrid transmission (10) for a motor vehicle drive train with an internal combustion engine (55) and an electric prime mover (18), comprising:
a first sub-transmission (10a) having a plurality of gear steps and a first transmission input shaft (12);
a second sub-transmission (10b) having a plurality of gear steps and a second transmission input shaft (14);
a countershaft (16);
a plurality of shift elements (A, B, C, D, E) for engaging the gear steps (1, 2, 3, 4, 5) of the first and second sub-transmissions (10a, 10b); and
a plurality of gearwheel pairs comprising idler gears (28, 32, 36, 40, 44) and fixed gears (26, 30, 34, 38, 42), the gearwheel pairs configured for forming the gear steps and arranged in a plurality of gear set planes,
wherein a portion of the gear steps of the first and second sub-transmissions (10a, 10b) is engageable for the internal combustion engine, and a portion of the gear steps of the first and second sub-transmissions (10a, 10b) is engageable for the electric prime mover, and
wherein the gearwheel pairs configured for forming the gear steps of the first and second sub-transmissions (10a, 10b) having the lowest and the second-lowest ratios are fixedly associated with the first sub-transmission.

16. The hybrid transmission (10) of claim 15, wherein:
the gear steps of the first and second sub-transmissions (10a, 10b) is five gear steps (1, 2, 3, 4, 5); and
all gear steps of the first and second sub-transmissions (10a, 10b) are engageable for the internal combustion engine (55) and the electric prime mover (18).

17. The hybrid transmission (10) of claim 15, wherein the one of the gearwheel pairs for the gear steps larger than the second gear step is arranged at one of the first and second sub-transmissions (10a, 10b), and the gearwheel pairs for gear steps adjacent the second gear step are arranged at the other of the first and second sub-transmissions (10a, 10b).

18. The hybrid transmission (10) of claim 15, wherein one or both of the first sub-transmission (10a) and the second sub-transmission (10b) is configured for establishing a power transmission path with one or both of the electric prime mover (18) and a further electric prime mover (22).

19. The hybrid transmission (10) of claim 18, wherein one or both of the first sub-transmission (10a) and the second sub-transmission (10b) is configured for establishing the power transmission path at the one of the fixed gears (38) of the gear pair that forms the highest gear step on the first sub-transmission or the second sub-transmission.

20. The hybrid transmission (10) of claim 18, wherein the one of the fixed gears (38, 42) arranged at one axial end of the hybrid transmission is configured for establishing the power transmission path with the electric prime mover (18) or the further electric prime mover (22).

21. The hybrid transmission (10) of claim 15, wherein one or more of:
the one of the idler gears (28, 32) of the first gear step together with a further gear-forming gearwheel pair for a shared shift element;
the one of the idler gears (28, 32) of the second gear step together with the further gear-forming gearwheel pair for the shared shift element;
the shift elements (A, B, C, D, E) are configured as form-locking shift elements; and
at least two shift elements (E, C, A, D) are configured as double shift elements (EC, AD).

22. The hybrid transmission (10) of claim 15, further comprising:
a first coupling element (K1); and
a second coupling element (K2),
wherein the first transmission input shaft (12) is operatively connectable to the internal combustion engine by the first coupling element (K1), and the second transmission input shaft (14) is operatively connectable to the internal combustion engine by the second coupling element (K2), and
wherein the first coupling element (K1) and the second coupling element (K2) are configured as form-locking coupling elements.

23. The hybrid transmission (10) of claim 22, wherein the first coupling element and the second coupling element are actuatable by a double-acting actuator.

24. The hybrid transmission (10) of claim 15, further comprising a connecting shift element (K3) configured for drivingly connecting the first transmission input shaft (12) and the second transmission input shaft (14).

25. The hybrid transmission (10) of claim 15, wherein:
the first transmission input shaft (12) and the second transmission input shaft (14) are arranged coaxially to each other; and
one of the first and second transmission input shafts (12, 14) is configured as a hollow shaft and at least partially encompasses the other of the first and second transmission input shafts (12, 14).

26. A motor vehicle drive train (11), comprising:
the internal combustion engine (55) configured for providing input power;
the electric prime mover (18) configured for providing input power; and
the hybrid transmission (10) of claim 15.

27. The motor vehicle drive train (11) of claim 26, further comprising a further electric prime mover (22) configured for providing input power.

28. The motor vehicle drive train (11) of claim 27, wherein one or both of the electric prime mover and the further electric prime mover is arranged axially parallel to one or both of the first transmission input shaft and the second transmission input shaft.
